(19) United States
(12) Patent Application Publication
(10) Pub. No.: US 2025/0284252 A1
(43) Pub. Date: Sep. 11, 2025

(54) SAFETY CONTROL METHOD AND INTELLIGENT DEVICE

(71) Applicant: JIANGSU DONGCHENG TOOLS TECHNOLOGY CO., LTD, Nantong (CN)

(72) Inventor: Jiang CHEN, Nantong (CN)

(21) Appl. No.: 18/859,646

(22) PCT Filed: Jun. 29, 2023
(86) PCT No.: PCT/CN2023/103614

§ 371 Date: Oct. 24, 2024

(30) Foreign Application Priority Data
Dec. 8, 2022 (CN) 202211571394.7

(51) Int. Cl. G05B 9/02; B25F 5/00

(52) U.S. Cl. CPC G05B 9/02; B25F 5/00

(57) ABSTRACT

The application provides a safety control method and an intelligent device. The method includes obtaining a plurality of angle values corresponding to each space angle of different space angles. A deviation value of each space angle is determined according to a maximum value and a minimum value among the plurality of angle values corresponding to each space angle. Once an error value is determined according to the deviation value of each space angle, whether to trigger a protection operation is determined according to the deviation value and/or the error value.

### TECHNICAL FIELD

The present application relates to safety controlling in an intelligent manufacturing field, and in particular to a safety control method applied to a power tool, an intelligent device and a computer-readable medium.

### BACKGROUND

As daily needs continue to increase, uses of power tools are becoming more and more extensive, and the number of people they are targeting is also increasing. With an increase in user demographics, power tools are no longer limited to professional use; many households also purchase and use power tools. Due to differences in professionalism, there are some dangers in a process of using the power tool, among which the kickback of tool is a common dangerous phenomenon.

In order to prevent the tool kickback, many technologies about preventing and reducing kickback of a power tool are provided. For example, China's patent issued No. CN213616506U proposes a solution to a problem that may be brought because of a kickback causing by the power tool being bound in a workpiece: a roll position of the power tool 102a is monitored by a combination of a directional sensor 345 and a motion sensor 350, and the roll position is a rotation angle, the sensor 345 and a sensor 350 allow a monitoring of a movement of the power tool from one axis to nine axes; an initial roll position and a current roll position in an operation are compared, and when a preset amount (an angle range of a working operation) is changed, a kickback is occurred; and a safety control is performed according to a detection result. However, parameters detected by the above solution are relatively simple, which is easy to cause misjudgment; at the same time, it is impossible to perform personalized settings according to user needs, and a user experience is poor.

In view of this, it is necessary to provide an improved power tool to overcome defects of the prior art.

### SUMMARY

In view of deficiencies in the prior art, a purpose of the present application is to provide an improved solution, which has characteristics of a high security control accuracy and can be personalized for different users to meet needs of different users.

The present application solves existing technical problems by adopting following technical solutions:
A safety control method, the method comprises:
A collection step: being used for collecting data of different spatial angles, and obtaining a plurality of angle values corresponding to each spatial angle of the different spatial angles;
A calculation step: obtaining a maximum value and a minimum value among the plurality of angle values corresponding to each spatial angle, and determining a deviation value of each spatial angle according to the maximum value and the minimum value;
A processing step: determining an error value according to the deviation value of each spatial angle; determining whether to trigger a protection operation according to the deviation value and/or the error value.

A further improved solution comprises that the safety control method further comprises: obtaining a safety factor for a user, and determining a safety threshold value of the deviation value and/or a safety threshold value of the error value based on the safety factor;
Determining whether to perform the protection operation based on the deviation value and/or the error value comprising: obtaining a comparison result by comparing the deviation value with a corresponding safety threshold value and/or obtaining a comparison result by comparing the error value with a corresponding safety threshold value;
Executing the protection operation when all comparison results meet conditions for triggering the protection operation.

A further improved solution comprises that the different spatial angles comprise a first spatial direction, a second spatial direction, and a third spatial direction;

The collection step comprises obtaining a plurality of angle values of the first spatial direction, a plurality of angle values of the second spatial direction, and a plurality of angle values of the third spatial directions;

The calculation step comprises: calculating an angular deviation value of the first spatial direction, an angular deviation value of the second spatial direction, and an angular deviation value of third spatial direction;

The processing step comprises: determining a plurality of error values by performing a cross comparison based on the angular deviation value of the first spatial direction, the angular deviation value of the second spatial direction, and the angular deviation value of third spatial direction;
Determining whether the protection operation needs to be triggered according to at least one angular deviation value and at least one error value.

A further improved solution comprises determining the plurality of error values by performing the cross comparison based on the angular deviation value of the first spatial direction, the angular deviation value of the second spatial direction, and the angular deviation value of third spatial direction comprises:
Determining a first error value according to the angular deviation value of the first spatial direction and the angular deviation value of the second spatial direction;
Determining a second error value according to the angular deviation value of the first spatial direction and the angular deviation value of the third spatial direction;
Determining whether the protection operation needs to be triggered according to the angular deviation value of the first spatial direction, the first error value, and the second error value.

A further improved solution comprises that after obtaining the plurality of angle values corresponding to each spatial angle of the different spatial angles, storing the plurality of angle values in a plurality of queues respectively;
Obtaining a maximum value and a minimum value in each queue, and determining the deviation value of each spatial angle according to the maximum value and the minimum value.

The present application further provides an intelligent apparatus, comprising:
A collecting module: being used for collecting data of different spatial angles and obtaining a plurality of angle values corresponding to each spatial angle of the different spatial angles;
A calculation module: obtaining a maximum value and a minimum value among the plurality of angle values corresponding to each spatial angle, and determining a deviation value of each spatial angle according to the maximum value and the minimum value;
A processing module: determining an error value according to the deviation value of each spatial angle: determining whether to trigger a protection operation according to the deviation value and/or the error value.

The present application further provides an intelligent device, comprising:
A collecting sensor, being used for collecting data of different spatial angles and obtaining a plurality of angle values corresponding to each spatial angle of the different spatial angles;
A processor obtaining a maximum value and a minimum value among the plurality of angle values corresponding to each spatial angle, and determining a deviation value of each spatial angle according to the maximum value and the minimum value; determining an error value according to the deviation value of each spatial angle; determining whether to trigger a protection operation according to the deviation value and/or the error value.

A further improved solution comprises that the collecting sensor is a six-axis sensor.

The present application further provides an intelligent device, comprising a storage device and a processor, wherein the storage device stores a computer program that can be run on the processor, the processor implements the method when executing the computer program.

The present application further provides a computer-readable medium having non-volatile program codes executable by a processor, wherein the program codes enable the processor to execute the method.

Compared with the prior art, the present application has following beneficial effects: the safety control method and the intelligent device provided by the present application obtain the plurality of angle values corresponding to each spatial angle of different spatial angles; determine the deviation value of each spatial angle according to the maximum value and the minimum value among the plurality of angle values corresponding to each spatial angle; determine the error value according to the deviation value of each spatial angle; determine whether to trigger the protection operation according to the deviation value and/or the error value. In the process of triggering the safety operation, a mutual influence between different spatial angles is comprehensively considered, which effectively prevents a false triggering of a safety operation and improves a control accuracy of an anti-kickback operation; at the same time, the solutions provided by the present application supports an adjustment of an accuracy of the triggering operation, which can meet safety needs of different users and improve a user experience.

### BRIEF DESCRIPTION OF THE DRAWINGS

Specific embodiments of the present application are further described in detail below in conjunction with accompanying drawings:

FIG. 1 is a flow chart of a method according to a preferred embodiment of the present application;

FIG. 2 is a flow chart of a method according to a preferred embodiment of the present application;

FIG. 3 is a schematic diagram of a structure of a preferred embodiment of the present application.

### DETAIL DESCRIPTION

The present application is further described in detail below in conjunction with the accompanying drawings and embodiments.

Terms used in the present application is for a purpose of describing particular embodiments only and is not intended to be limiting of the present application.

An intelligent device described in the present application may be a power tool/an electric device, where the power tool/electric device may be a garden tool, a handheld tool, or other automated device with an anti-kickback function; as long as the device/tool can adopt essential content of the technical solution disclosed below, it can fall within a protection scope of the present application.

Due to differences in personnel expertise, some dangers may arise during the use of the power tools, such as the kickback is the common dangerous phenomenon. An anti-kickback technology is one of functions to ensure a user safety during the use of tools; however, in the prior art, during a process of triggering an anti-kickback operation, a determination method is simple and is easy to make a misjudgment; at the same time, it is not possible to perform personalized settings according to user needs, resulting in a poor user experience. In view of the deficiencies of the prior art, the purpose of the present application is to provide an improved solution, which has the characteristics of the high safety control accuracy and the ability to perform personalized settings for different users to meet the needs of different users.

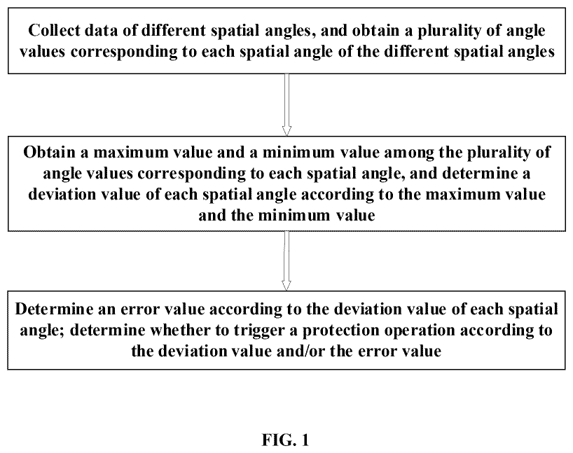

The present application solves the existing technical problems by adopting the following technical solutions: a safety control method, as shown in FIG. 1, the method includes:

A collection step: used for collecting data of different spatial angles, and obtaining a plurality of angle values corresponding to each spatial angle of the different spatial angles:

A calculation step: obtaining a maximum value and a minimum value among the plurality of angle values corresponding to each spatial angle, and determining a deviation value of each spatial angle according to the maximum value and the minimum value;

A processing step: determining an error value according to the deviation value of each spatial angle; determining whether to trigger a protection operation according to the deviation value and/or the error value.

By obtaining the plurality of angle values corresponding to each spatial angle of different spatial angles; determining the deviation value of each spatial angle according to the maximum value and the minimum value of the plurality of angle values corresponding to each spatial angle; determining the error value according to the deviation value of each spatial angle; and determining whether to trigger the protection operation according to the deviation value and/or the error value. In the process of triggering the safety operation, a mutual influence between different spatial angles is comprehensively considered, which effectively prevents a false triggering of the safety operation and improves a control accuracy of the anti-kickback operation.

Preferably, the method further includes: obtaining a safety factor for a user, and determining a safety threshold value of the deviation value and/or a safety threshold value of the error value based on the safety factor; determining whether to perform the protection operation based on the deviation value and/or the error value, includes: obtaining a comparison result by comparing the deviation value with a corresponding safety threshold value and/or obtaining a comparison result by comparing the error value with a corresponding safety threshold value: when all comparison results meet conditions for triggering the protection operation, executing the protection operation.

Preferably, the safety threshold can be determined by a human-computer interaction module. Since different users have different requirements for safety operations, that is, each user has a different control for the rotation angle, the tool can provide a recommended value or a default value; experienced users or new users can also set it according to their needs.

In the preferred embodiment, because in actual work, the handheld tool shakes or a kickback slightly generated by humans as necessary, which causes changes in a position angle, so a time measurement must be added on a basis of an angle detection. It is found that, taking an electric hammer as an example, when a drill bit of the electric hammer is stuck on a wall, a body rotates at a very fast speed (a trigger switch is not disconnected) when a handle is released. An initial rotation speed of the body measured at this time is about 1 to 3 revolutions per second, and a corresponding angle is 360°−1080°.

| | Number of | | Rotation angle |
|---|---|---|---|
| | revolutions | Time (ms) | (°) |
| Minimum number of | 1 | 1000 | 360 |
| revolutions | | | |
| Maximum number of | 3 | 1000 | 1080 |
| revolutions | | | |

If the anti-kickback protection is turned on after one second of detection, the body of the device has already rotated to a large angle, which may injure the user. Generally speaking, the protection operation needs to be triggered as quickly as possible. Based on this, a rotation angle value at each time can be calculated.

| | | Setting time (ms) | | |
|---|---|---|---|---|
| | | 10 | 30 | 100 |
| Rotation | Minimum number | 3.6 | 10.8 | 36 |
| angle (°) | of revolutions | | | |
| | Maximum number | 10.8 | 32.4 | 108 |
| | of revolutions | | | |

When the body rotates 108° within 100 ms, it means there is a danger and the user may not be able to react in time. Therefore, it must be controlled within this range when setting the safety threshold value. According to actual measurements, if the body rotates 3 revolutions per second, the user's hand may not be able to control a rotating body; when it rotates 1 revolution per second, it is basically at a zero boundary point. Therefore, threshold parameters can be set according to a proficiency of use. Furthermore, in order to prevent a misjudgment and a false triggering of the anti-kickback operation, the safety threshold value is further adjusted, and the parameters are as follows.

Setting time (ms)

| | | 30 | 100 |
|---|---|---|---|
| Rotation | Low-precision | 7 | 30 |
| angle (°) | detection | | |
| | High-precision | 5 | 15 |
| | detection | | |

Preferably, in order to facilitate the user to perform safety settings through the human-machine operation module, it can be set by an angle or a number of revolutions (i.e., safety factor), such as following recommendation information of safety threshold values is provided, and the user can set or adjust it according to the following information. For example, a professional user who is familiar with the tool can adjust or set it according to a requirement of a low-precision detection; a new user can adjust or set it according to a requirement of a high-precision detection; thereby meeting the use needs of different users and improving the user experience.

| | |
|---|---|
| °/sec | revolutions/sec |

| | | | | |
|---|---|---|---|---|
| Low-precision | 233.3 | 300.0 | 0.6 | 0.8 |
| detection | | | | |
| High-precision | 166.7 | 150.0 | 0.5 | 0.4 |
| detection | | | | |

Preferably, the different spatial angles include a first spatial direction, a second spatial direction, and a third spatial direction; preferably, the first spatial direction, the second spatial direction, and the third spatial direction are respectively a X spatial direction, a Y spatial direction, and a Z spatial direction in a three-dimensional space; taking X as an anti-kickback direction as an example: collecting an angle value obtained in a unit time, collecting n groups of data, where the unit time can be set by the user, or set according to a number of safety revolutions, such as 10 ms, 30 ms, 100 ms, etc.; n can be a length of a storage space, such as when an array is used for a storage, n is the length of the array, and when a queue is used for the storage, n is the length of the queue. The collection step includes obtaining a plurality of angle values of the first spatial direction, a plurality of angle values of the second spatial direction, and a plurality of angle values of the third spatial directions;

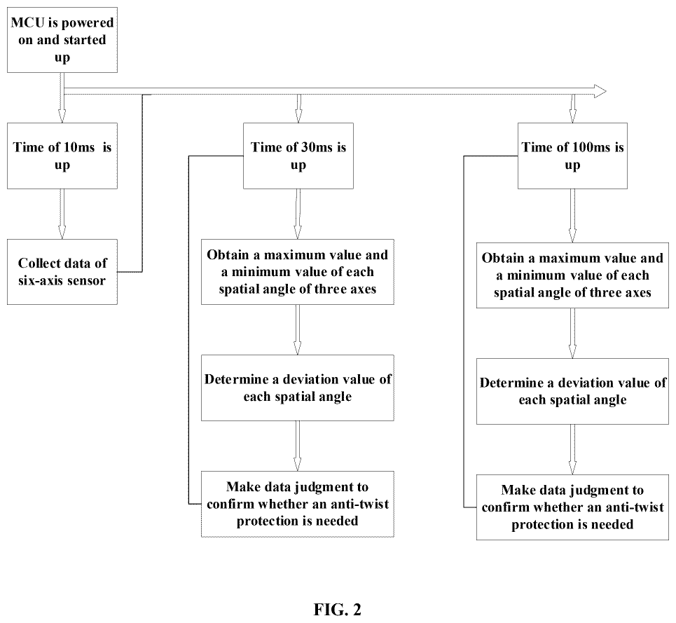

Preferably. X, Y, and Z spatial angles are detected and calculated every 10 ms; the intelligent device collects data at each unit time interval, and when the trigger condition is detected to be met, such as when the time is 30 ms, 100 ms, etc., or when the number of stored data is n, an anti-kickback judgment is made, as shown in FIG. 2. The tool collects data of angle values according to a preset sampling period.

Angle value obtained per unit time (°)

| | | | | | |
|---|---|---|---|---|---|
| X | X1 | X2 | X3 | . . . | Xn |
| Y | Y1 | Y2 | Y3 | . . . | Y |
| Z | Z1 | Z2 | Z3 | . . . | Zn |

After completing data collection, a maximum value “Max” and a minimum value “Min” of the plurality of angle values corresponding to each spatial angle are obtained:

| | Obtain the minimum angle value |
|---|---|
| Obtain the maximum value “Max” | “Min” |
| Max(x) = {X1, X2, X3 . . . Xn} | Min(x) = {X1, X2, X3 . . . Xn} |
| Max(y) = {Y1, Y2, Y3 . . . Yn} | Min(y) = {Y1, Y2, Y3 . . . Yn} |
| Max(z) = {Z1, Z2, Z3 . . . Zn} | Min(z) = {Z1, Z2, Z3 . . . Zn} |

The calculation step includes: calculating an angular deviation value of the first spatial direction, an angular deviation value of the second spatial direction, and an angular deviation value of third spatial direction; specifically includes: determining the deviation value of each spatial angle according to the maximum value and the minimum value:

| Deviation value | Calculate the deviation value |
|---|---|
| Err(x) | Err(x) = Max(x)-Min(x) |
| Err(y) | Err(y) = Max(y)-Min(y) |
| Err(z) | Err(z) = Max(z)-Min(z) |

The processing step includes: performing a cross comparison based on the angular deviation value of the first spatial direction, the angular deviation value of the second spatial direction, and the angular deviation value of third spatial direction to determine a plurality of error values;

Determining whether a protection operation needs to be triggered according to at least one angular deviation value and at least one error value.

Preferably, performing the cross-comparison based on the angular deviation values of the first, second and third spatial directions to determine the plurality of error values, includes:
Determining a first error value according to the angular deviation value of the first spatial direction and the angular deviation value of the second spatial direction, such as a first error value Err(xy) between the X direction and in the Y direction;
Determining a second error value according to the angular deviation value of the first spatial direction and the angular deviation value of the third spatial direction, such as a second error value Err(xz) between the X direction and in the Z direction;

| Maximum difference Err(n) | Calculate an error value |
|---|---|
| Err(y) | Err(xy) = Err(x)-Err(y) |
| Err(z) | Err(xz) = Err(x)-Err(z) |

Determining whether the protection operation needs to be triggered according to the angular deviation value of the first spatial direction, the first error value, and the second error value. Preferably, a safety operation of triggering the anti-kickback protection can be set according to actual needs, such as being triggered when at least one of the following conditions is met. Take the first direction as the X direction as an example:

Conditions (when both are met)

| | | |
|---|---|---|
| Unit time | Err(x) > a preset rotation angle | Trigger the |
| | Err(xy) > a preset rotation angle | anti-kickback |
| | Err(xz) > a preset rotation angle | protection |

Exemplarily, conditions for triggering the anti-kickback protection at 30 ms and conditions for triggering the anti-kickback protection to 100 ms are as follows:

| Conditions (when both are met) | | |
|---|---|---|
| at 30 ms | Err(x)_30 ms > a preset rotation angle (7°) | Trigger the |
| | Err(xy)_30 ms > a preset rotation angle (7°) | anti-kickback |
| | Err(xz)_30 ms > a preset rotation angle (7°) | protection |
| at 100 ms | Err(x)_100 ms > a preset rotation angle (30°) | Trigger the |
| | Err(xy)_100 ms > a preset the rotation angle (30°) | anti-kickback |
| | Err(xz)_100 ms > a preset the rotation angle (30°) | protection |

Preferably, when the Y direction is taken as an example, Err(y), Err(yx), Err(yz) are calculated and compared with a preset selected angle, and the anti-kickback protection is triggered according to a comparison result; when the Z direction is taken as an example, Err(z), Err(zx), Err(zy) are calculated and compared with a preset selected angle, and the anti-kickback protection is triggered according to a comparison result. Among them, the preset rotation angle is the safety threshold value, and a specific setting method is as described above and will not be repeated here.

Preferably: after the plurality of angle values corresponding to each spatial angle of different spatial angles is obtained, the plurality of angle values is stored in a plurality of queues respectively; a maximum value and a minimum value in each queue are obtained, and the deviation value of each spatial angle is determined according to the maximum value and the minimum value. When storing data, data can be selected for storage, or queues can be used for storage. When using an array for storage, the safety protection operation, i.e., the anti-kickback protection, is triggered every preset time or when data stored in the array reaches a preset value; where the preset time and the preset value are set according to actual needs, which is a common means and will not be repeated here. When a storage queue is used for storage, a first-in-first-out queue is preferably used, and a queue length is n: thus, the device only needs to update and process n data in the queue; further, each spatial angle corresponds to one first-in-first-out queue; the maximum value and the minimum value in each queue are calculated, and the deviation value is determined according to the maximum value and the minimum value to realize the triggering operation of safety protection. The first-in-first-out queue can reduce a data storage pressure of the system, and a judgment and an identification can be performed every time a data is collected, which can effectively increase a detection frequency; at the same time, an increase in the detection frequency effectively improves the detection accuracy and improve the safety factor of the product.

Compared with the prior art, the present application provides the safety control method, which obtains the plurality of angle values corresponding to each spatial angle of different spatial angles; determines the deviation value of each spatial angle according to the maximum value and the minimum value of the plurality of angle values corresponding to each spatial angle; determines the error value according to the deviation value of each spatial angle; and determines whether to trigger the protection operation according to the deviation value and/or the error value. In the process of triggering the safety operation, the mutual influence between different spatial angles is comprehensively considered, which effectively prevents the false triggering of the safety operation and improves the control accuracy of the anti-kickback operation; at the same time, the solution provided by the present application supports an adjustment of a precision of the triggering operation, which can meet safety needs of different users and improve the user experience.

### Second Embodiment

The present application further provides an intelligent apparatus, through which the solution described in the first embodiment is implemented; the intelligent apparatus includes:
A collecting module, which is used for collecting data of different spatial angles and obtaining a plurality of angle values corresponding to each spatial angle of the different spatial angles;
A calculation module, obtaining a maximum value and a minimum value among the plurality of angle values corresponding to each spatial angle, and determining a deviation value of each spatial angle according to the maximum value and the minimum value;
A processing module, determining an error value according to the deviation value of each spatial angle; determining whether to trigger a protection operation according to the deviation value and/or the error value.

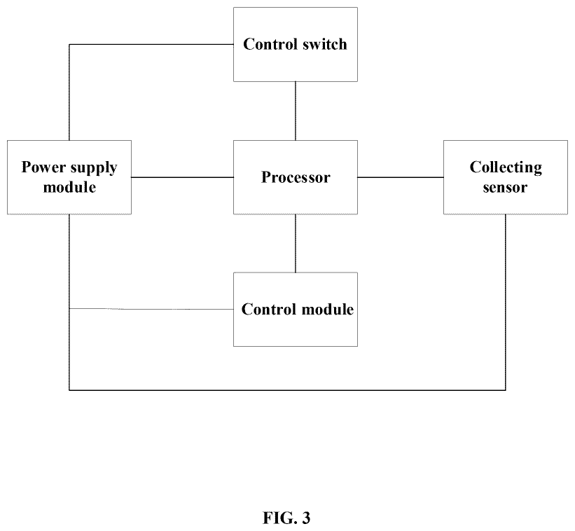

In an alternative solution, the present application further provides an intelligent device, through which the solution described in the first embodiment is implemented; as shown in FIG. 3, the intelligent device includes a collecting sensor, a processor, a control switch, a power supply module, a motor, etc.; after turning on the control switch, the power supply module supplies power to a control module and the motor, the intelligent device starts working, and the processor triggers a safety protection operation based on the information of the collecting sensor.

The intelligent device includes:
The collecting sensor, which is used for collecting data of different spatial angles and obtaining a plurality of angle values corresponding to each spatial angle of the different spatial angles;
The processor, which is used for obtaining a maximum value and a minimum value among the plurality of angle values corresponding to each spatial angle, and determining a deviation value of each spatial angle according to the maximum value and the minimum value; determining an error value according to the deviation value of each spatial angle; determining whether to trigger a protection operation according to the deviation value and/or the error value.

A further improvement is that the collecting sensor is a six-axis sensor.

Preferably, the method of obtaining the safety factor for the user, and determining the safety threshold value of the deviation value and/or the safety threshold value of the error value based on the safety factor; determining whether to perform the protection operation based on the deviation value and/or the error value includes: obtaining a comparison result by comparing the deviation value with a corresponding safety threshold value and/or obtaining a comparison result by comparing the error value with a corresponding safety threshold value; executing the protection operation when all comparison results meet conditions for triggering the protection operation.

Preferably, the safety threshold can be determined by a human-computer interaction module. Since different users have different requirements for safety operations, that is, each user has a different control for the rotation angle, the tool can provide a recommended value or a default value; experienced users or new users can also set it according to their needs.

In the preferred embodiment, because in actual work, the handheld tool shakes or a kickback slightly generated by humans as necessary, which causes changes in a position angle, so a time measurement must be added on a basis of an angle detection. It is found that, taking an electric hammer as an example, when a drill bit of the electric hammer is stuck on a wall, a body rotates at a very fast speed (a trigger switch is not disconnected) when a handle is released. An initial rotation speed of the body measured at this time is about 1 to 3 revolutions per second, and a corresponding angle is 360°-1080°.

| | Number of | | Rotation angle |
|---|---|---|---|
| | revolutions | Time (ms) | (°) |
| Minimum number | 1 | 1000 | 360 |
| of revolutions | | | |
| Maximum number | 3 | 1000 | 1080 |
| of revolutions | | | |

If the anti-kickback protection is turned on after one second of detection, the body of the device has already rotated to a large angle, which may injure the user. Generally speaking, the protection operation needs to be triggered as quickly as possible. Based on this, a rotation angle value at each time can be calculated.

| | | Setting time (ms) | | |
|---|---|---|---|---|
| | | 10 | 30 | 100 |
| Rotation | Minimum number | 3.6 | 10.8 | 36 |
| angle (°) | of revolutions | | | |
| | Maximum number | 10.8 | 32.4 | 108 |
| | of revolutions | | | |

When the body rotates 108° within 100 ms, it means there is a danger and the user may not be able to react in time. Therefore, it must be controlled within this range when setting the safety threshold value. According to actual measurements, if the body rotates 3 revolutions per second, the user's hand may not be able to control a rotating body; when it rotates 1 revolution per second, it is basically at a zero boundary point. Therefore, threshold parameters can be set according to a proficiency of use. Furthermore, in order to prevent a misjudgment and a false triggering of the anti-kickback operation, the safety threshold value is further adjusted, and the parameters are as follows.

Setting time (ms)

| | | 30 | 100 |
|---|---|---|---|
| Rotation | Low-precision | 7 | 30 |
| angle (°) | detection | | |
| | High-precision | 5 | 15 |
| | detection | | |

Preferably, in order to facilitate the user to perform safety settings through the human-machine operation module, it can be set by an angle or a number of revolutions, such as following recommendation information of safety threshold values is provided, and the user can set or adjust it according to the following information. For example, a professional user who is familiar with the tool can adjust or set it according to a requirement of a low-precision detection; a new user can adjust or set it according to a requirement of a high-precision detection; thereby meeting the use needs of different users and improving the user experience.

| | |
|---|---|
| °/sec | revolutions/sec |

| | | | | |
|---|---|---|---|---|
| Low-precision | 233.3 | 300.0 | 0.6 | 0.8 |
| detection | | | | |
| High-precision | 166.7 | 150.0 | 0.5 | 0.4 |
| detection | | | | |

Preferably, the different spatial angles include a first spatial direction, a second spatial direction, and a third spatial direction; preferably, the first spatial direction, the second spatial direction, and the third spatial direction are respectively a X spatial direction, a Y spatial direction, and a Z spatial direction in a three-dimensional space; taking X as an anti-kickback direction as an example: collecting an angle value obtained in a unit time, collecting n groups of data, where the unit time can be set by the user, or set according to a number of safety revolutions, such as 10 ms, 30 ms, 100 ms, etc.; n can be a length of a storage space, such as when an array is used for a storage, n is the length of the array, and when a queue is used for the storage, n is the length of the queue. The collection step includes obtaining a plurality of angle values of the first spatial direction, a plurality of angle values of the second spatial direction, and a plurality of angle values of the third spatial directions;

Preferably, X, Y, and Z spatial angles are detected and calculated every 10 ms; the intelligent device collects data at each unit time interval, and when the trigger condition is detected to be met, such as when the time is 30 ms, 100 ms, etc., or when the number of stored data is n, an anti-kickback judgment is made, as shown in FIG. 2. The tool collects data of angle values according to a preset sampling period.

Angle obtained per unit time (°)

| | | | | | |
|---|---|---|---|---|---|
| X | X1 | X2 | X3 | . . . | Xn |
| Y | Y1 | Y2 | Y3 | . . . | Y |
| Z | Z1 | Z2 | Z3 | . . . | Zn |

After completing data collection, a maximum value “Max” and a minimum value “Min” of the plurality of angle values corresponding to each spatial angle are obtained:

| | Obtain the minimum angle value |
|---|---|
| Obtain the maximum value “Max” | “Min” |
| Max(x) = {X1, X2, X3 . . . Xn} | Min(x) = {X1, X2, X3 . . . Xn} |
| Max(y) = {Y1, Y2, Y3 . . . Yn} | Min(y) = {Y1, Y2, Y3 . . . Yn} |
| Max(z) = {Z1, Z2, Z3 . . . Zn} | Min(z) = {Z1, Z2, Z3 . . . Zn} |

The calculation step includes: calculating an angular deviation value of the first spatial direction, an angular deviation value of the second spatial direction, and an angular deviation value of third spatial direction; specifically includes: determining the deviation value of each spatial angle according to the maximum value and the minimum value:

| Deviation value | Calculate the deviation value |
|---|---|
| Err(x) | Err(x) = Max(x)-Min(x) |
| Err(y) | Err(y) = Max(y)-Min(y) |
| Err(z) | Err(z) = Max(z)-Min(z) |

The processing step includes: performing a cross comparison based on the angular deviation value of the first spatial direction, the angular deviation value of the second spatial direction, and the angular deviation value of third spatial direction to determine a plurality of error values;
Determining whether a protection operation needs to be triggered according to at least one angular deviation value and at least one error value.

Preferably, performing the cross-comparison based on the angular deviation values of the first, second and third spatial directions to determine the plurality of error values, includes:
Determining a first error value according to the angular deviation value of the first spatial direction and the angular deviation value of the second spatial direction, such as a first error value Err(xy) between the X direction and in the Y direction;
Determining a second error value according to the angular deviation value of the first spatial direction and the angular deviation value of the third spatial direction, such as a second error value Err(xz) between the X direction and in the Z direction;

| Maximum difference Err(n) | Calculate an error value |
|---|---|
| Err(y) | Err(xy) = Err(x)-Err(y) |
| Err(z) | Err(xz) = Err(x)-Err(z) |

Determining whether the protection operation needs to be triggered according to the angular deviation value of the first spatial direction, the first error value, and the second error value. Preferably, a safety operation of triggering the anti-kickback protection can be set according to actual needs, such as being triggered when at least one of the following conditions is met. Take the first direction as the X direction as an example:

Conditions (when both are met)

| | | |
|---|---|---|
| Unit time | Err(x) > a preset rotation angle | Trigger the |
| | Err(xy) > a preset rotation angle | anti-kickback |
| | Err(xz) > a preset rotation angle | protection |

Exemplarily, conditions for triggering the anti-kickback protection at 30 ms and conditions for triggering the anti-kickback protection to 100 ms are as follows:

| Conditions (when both are met) | | |
|---|---|---|
| at 30 ms | Err(x)_30 ms > a preset rotation angle (7°) | Trigger the |
| | Err(xy)_30 ms > a preset rotation angle (7°) | anti-kickback |
| | Err(xz)_30 ms > a preset rotation angle (7°) | protection |
| at 100 ms | Err(x)_100 ms > a preset rotation angle (30°) | Trigger the |
| | Err(xy)_100 ms > a preset the rotation angle (30°) | anti-kickback |
| | Err(xz)_100 ms > a preset the rotation angle (30°) | protection |

Preferably, when the Y direction is taken as an example, Err(y), Err(yx), Err(yz) are calculated and compared with a preset selected angle, and the anti-kickback protection is triggered according to a comparison result; when the Z direction is taken as an example, Err(z), Err(zx), Err(zy) are calculated and compared with a preset selected angle, and the anti-kickback protection is triggered according to a comparison result. Among them, the preset rotation angle is the safety threshold value, and a specific setting method is as described above and will not be repeated here.

Preferably, after the plurality of angle values corresponding to each spatial angle of different spatial angles is obtained, the plurality of angle values is stored in a plurality of queues respectively; a maximum value and a minimum value in each queue are obtained, and the deviation value of each spatial angle is determined according to the maximum value and the minimum value. When storing data, data can be selected for storage, or queues can be used for storage. When using an array for storage, the safety protection operation, i.e., the anti-kickback protection, is triggered every preset time or when data stored in the array reaches a preset value; where the preset time and the preset value are set according to actual needs, which is a common means and will not be repeated here. When a storage queue is used for storage, a first-in-first-out queue is preferably used, and a queue length is n; thus, the device only needs to update and process n data in the queue; further, each spatial angle corresponds to one first-in-first-out queue; the maximum value and the minimum value in each queue are calculated, and the deviation value is determined according to the maximum value and the minimum value to realize the triggering operation of safety protection. The first-in-first-out queue can reduce a data storage pressure of the system, and a judgment and an identification can be performed every time a data is collected, which can effectively increase a detection frequency; at the same time, an increase in the detection frequency effectively improves the detection accuracy and improve the safety factor of the product.

The present application also provides an intelligent device, including a storage device and a processor, where the storage device stores a computer program that can be run on the processor, and when the processor executes the computer program, the method described in the first embodiment is implemented.

The present application also provides a computer-readable medium having non-volatile program codes executable by a processor, where the program codes enables the processor to execute the method described in the first embodiment.

Compared with the prior art, the present application provides a safety control solution, which obtains the plurality of angle values corresponding to each spatial angle of different spatial angles; determines the deviation value of each spatial angle according to the maximum value and the minimum value of the plurality of angle values corresponding to each spatial angle; determines the error value according to the deviation value of each spatial angle; and determines whether to trigger the protection operation according to the deviation value and/or the error value. In the process of triggering the safety operation, the mutual influence between different spatial angles is comprehensively considered, which effectively prevents the false triggering of the safety operation and improves the control accuracy of the anti-kickback operation; at the same time, the solution provided by the present application supports the adjustment of the triggering operation accuracy, which can meet the safety needs of different users and improve the user experience.

Those skilled in the art would appreciate that embodiments of the present application may be provided as methods, systems, or computer program products. Therefore, the present application may take a form of a complete hardware embodiment, a complete software embodiment, or an embodiment combining software and hardware. Moreover, the present application may take a form of a computer program product implemented on one or more computer-usable storage medium (including but not limited to a disk storage, a CD-ROM, an optical storage, etc.) including computer-usable program codes.

The present application is described with reference to the flowchart and/or block diagram of the method, device (system), and computer program product according to the embodiments of the present application. It should be understood that each process and/or box in the flowchart and/or block diagram, as well as the combination of the process and/or box in the flowchart and/or block diagram can be implemented by computer program instructions. These computer program instructions can be provided to a processor of a general-purpose computer, a special-purpose computer, an embedded processor or other programmable data processing device to produce a machine, so that the instructions executed by the processor of the computer or other programmable data processing device produce a device for implementing the functions specified in one or more processes in the flowchart and/or one or more boxes in the block diagram.

These computer program instructions may also be stored in a computer-readable storage device that can direct a computer or other programmable data processing device to work in a specific manner, so that the instructions stored in the computer-readable storage device produce a product including an instruction device that implements specified functions in one or more processes in the flowchart and/or one or more boxes in the block diagram.

These computer program instructions may also be loaded onto a computer or other programmable data processing device so that a series of operational steps are executed on the computer or other programmable device to produce a computer-implemented process, whereby the instructions executed on the computer or other programmable device provide steps for implementing the specified functions in one or more processes in the flowchart and/or one or more boxes in the block diagram.

Those skilled in the art can clearly understand that, for the convenience and brevity of description, the specific working process of the system and device described above can refer to the corresponding process in the aforementioned method embodiment, and will not be repeated here.

Finally, it should be noted that the above-described embodiments are only specific implementations of the present application, which are used to illustrate the technical solutions of the present application, rather than to limit them. The protection scope of the present application is not limited thereto. Although the present application is described in detail with reference to the above-described embodiments, it should be understood by those skilled in the art that any person familiar with the technical field can still modify the technical solutions recorded in the above-described embodiments within the technical scope disclosed by the present application, or can easily think of changes, or perform equivalent replacements on some of the technical features thereof; and these modifications, changes or replacements do not make the essence of the corresponding technical solutions deviate from the spirit and scope of the technical solutions of the embodiments of the present application, and should be included in the protection scope of the present application. Therefore, the protection scope of the present application shall be subject to the protection scope of the claims.

1-10. (canceled)

11. A safety control method, wherein the safety control method comprises:
obtaining a plurality of angle values corresponding to each spatial angle of a plurality of spatial angles;
obtaining a maximum value and a minimum value among the plurality of angle values corresponding to each spatial angle, and determining a deviation value of each spatial angle according to the maximum value and the minimum value;
determining an error value according to the deviation value of each spatial angle; and
determining whether to trigger a protection operation according to at least one of the deviation value and the error value.

12. The safety control method according to claim 11, further comprising:
obtaining a safety factor, and determining a safety threshold value of the deviation value and a safety threshold value of the error value based on the safety factor;
wherein whether to trigger the protection operation according to at least one of the deviation value and the error value comprises:
obtaining a comparison result by comparing the deviation value with the safety threshold value of the deviation value and obtaining a comparison result by comparing the error value with the safety threshold value of the error value; and
executing the protection operation when each of all comparison results meets a corresponding condition for triggering the protection operation.

13. The safety control method according to claim 12, wherein each of all comparison results meeting the corresponding condition comprises:
the deviation value being greater than the safety threshold value of the deviation value and the error value being greater than the safety threshold value of the error value.

14. The safety control method according to claim 13, wherein the safety threshold value of the deviation value is equal to the safety threshold value of the error value.

15. The safety control method according to claim 12, further comprising:
determining the safety factor in response to input by a user.

16. The safety control method according to claim 11, wherein the plurality of angle values comprises angle values collected in a first spatial direction, angle values collected in a second spatial direction, and angle values collected in a third spatial direction.

17. The safety control method according to claim 16,
wherein determining the deviation value of each spatial angle comprises: calculating an angular deviation value of the first spatial direction, an angular deviation value of the second spatial direction, and an angular deviation value of third spatial direction;
wherein determining the error value according to the deviation value of each spatial angle comprises: determining a plurality of error values by performing a cross comparison based on the angular deviation value of the first spatial direction, the angular deviation value of the second spatial direction, and the angular deviation value of third spatial direction; and
determining whether to trigger the protection operation according to at least one angular deviation value and at least one error value.

18. The safety control method according to claim 17, wherein determining the plurality of error values by performing the cross comparison based on the angular deviation value of the first spatial direction, the angular deviation value of the second spatial direction, and the angular deviation value of third spatial direction comprises:
determining a first error value according to the angular deviation value of the first spatial direction and the angular deviation value of the second spatial direction;
determining a second error value according to the angular deviation value of the first spatial direction and the angular deviation value of the third spatial direction; and
determining whether to trigger the protection operation according to the angular deviation value of the first spatial direction, the first error value, and the second error value.

19. The safety control method according to claim 16, wherein the first spatial direction represents a X spatial direction, the second spatial direction represents a Y spatial direction, and the third spatial direction represents a Z spatial direction, the X spatial direction, the Y spatial direction, and the Z spatial direction are in a same three-dimensional space.

20. The safety control method according to claim 11, further comprising:
after obtaining the plurality of angle values corresponding to each spatial angle of the plurality of spatial angles, storing the plurality of angle values corresponding to each spatial angle in one of a plurality of queues; and
obtaining a maximum value and a minimum value in each queue of the plurality of queues, and determining the deviation value of each spatial angle according to the maximum value and the minimum value in each queue.

21. An intelligent device, wherein the intelligent device comprises:
a collecting sensor, configured for collecting data of spatial angles and obtaining a plurality of angle values corresponding to each spatial angle of the spatial angles;
at least one processor, configured for obtaining a maximum value and a minimum value among the plurality of angle values corresponding to each spatial angle, determining a deviation value of each spatial angle according to the maximum value and the minimum value; determining an error value according to the deviation value of each spatial angle; and determining whether to trigger a protection operation according to at least one of the deviation value and the error value.

22. The intelligent device according to claim 21, wherein the collecting sensor is a six-axis sensor.

23. An intelligent device comprises a storage device and at least one processor, wherein the storage device stores a computer program, which when executed by the processor, causes the at least one processor to:
obtain a plurality of angle values corresponding to each spatial angle of a plurality of spatial angles;
obtain a maximum value and a minimum value among the plurality of angle values corresponding to each spatial angle, and determine a deviation value of each spatial angle according to the maximum value and the minimum value;
determine an error value according to the deviation value of each spatial angle; and
determine whether to trigger a protection operation according to at least one of the deviation value and the error value.

24. The intelligent device according to claim 23, wherein the at least one processor is further caused to:
obtain a safety factor, and determine a safety threshold value of the deviation value and a safety threshold value of the error value based on the safety factor;
wherein whether to trigger the protection operation according to at least one of the deviation value and the error value comprises:
obtaining a comparison result by comparing the deviation value with the safety threshold value of the deviation value and obtaining a comparison result by comparing the error value with the safety threshold value of the error value; and
executing the protection operation when each of all comparison results meets a corresponding condition for triggering the protection operation.

25. The intelligent device according to claim 24, wherein each of all comparison results meeting the corresponding condition comprises:
the deviation value being greater than the safety threshold value of the deviation value and the error value being greater than the safety threshold value of the error value.

26. The intelligent device according to claim 24, wherein the plurality of angle values comprises angle values collected in a first spatial direction, angle values collected in a second spatial direction, and angle values collected in a third spatial direction.

27. The intelligent device according to claim 26,
wherein the at least one processor determines the deviation value of each spatial angle by: calculating an angular deviation value of the first spatial direction, an angular deviation value of the second spatial direction, and an angular deviation value of third spatial direction;
wherein the at least one processor determines the error value according to the deviation value of each spatial angle by: determining a plurality of error values by performing a cross comparison based on the angular deviation value of the first spatial direction, the angular deviation value of the second spatial direction, and the angular deviation value of third spatial direction;
wherein the at least one processor determines whether to trigger the protection operation according to at least one angular deviation value and at least one error value.

28. The intelligent device according to claim 27, wherein the at least one processor determines the plurality of error values by performing the cross comparison based on the angular deviation value of the first spatial direction, the angular deviation value of the second spatial direction, and the angular deviation value of third spatial direction by:
determining a first error value according to the angular deviation value of the first spatial direction and the angular deviation value of the second spatial direction;
determining a second error value according to the angular deviation value of the first spatial direction and the angular deviation value of the third spatial direction; and
determining whether to trigger the protection operation according to the angular deviation value of the first spatial direction, the first error value, and the second error value.

29. The intelligent device according to claim 27, wherein the first spatial direction, the second spatial direction, and the third spatial direction are respectively a X spatial direction, a Y spatial direction, and a Z spatial direction, the X spatial direction, the Y spatial direction, and the Z spatial direction are in a same three-dimensional space.

30. The intelligent device according to claim 23, wherein the at least one processor is further caused to:
after obtaining the plurality of angle values corresponding to each spatial angle of the plurality of spatial angles, store the plurality of angle values corresponding to each spatial angle in one of a plurality of queues; and
obtain a maximum value and a minimum value in each queue of the plurality of queues, and determine the deviation value of each spatial angle according to the maximum value and the minimum value in each queue.
